(19) United States
(12) Patent Application Publication
(10) Pub. No.: US 2025/0084503 A1
(43) Pub. Date: Mar. 13, 2025

(54) TREATMENT OF ZINC LEACH RESIDUE

(71) Applicant: GLENCORE TECHNOLOGY PTY LIMITED, Brisbane (QLD) (AU)

(72) Inventors: Alistair Stewart BURROWS, Ust-Kamenogorsk (KZ); Leonid Albertovich USHKOV, Ust-Kamenogorsk (KZ); Turarbek Anarbekovich AZEKENOV, Ust-Kamenogorsk (KZ)

(73) Assignee: GLENCORE TECHNOLOGY PTY LIMITED, Brisbane (QLD) (AU)

(21) Appl. No.: 18/580,782

(22) PCT Filed: Jul. 29, 2022
(86) PCT No.: PCT/AU2022/050815

§ 371 Date: Jan. 19, 2024

(30) Foreign Application Priority Data
Jul. 29, 2021 (AU) 2021902331

(51) Int. Cl. C22B 19/30; C22B 11/02; C22B 15/00

(52) U.S. Cl. CPC C22B 19/30; C22B 11/023; C22B 15/003; C22B 15/005; C22B 15/0054; C22B 15/0097

(57) ABSTRACT

According to the present invention there is provided a method for treating a zinc leach residue comprising the steps of: adding the zinc leach residue and a sulfide material comprising copper and flux to a furnace having a molten bath therein; operating the furnace to produce a matte comprising copper and a slag comprising zinc; separating the matte from the slag; and recovering zinc from the slag. The method preferably comprises the additional step of recovering the copper and/or other precious metals such as silver and gold, from the matte.

### FIELD OF THE INVENTION

The present invention relates to a method for treating zinc leach residue so as to recover valuable metals such as zinc therefrom and to remediate an otherwise hazardous waste stream from traditional zinc metallurgy.

Although the present invention will be described hereinafter with reference to its preferred embodiment, it will be appreciated by those of skill in the art that the spirit and scope of the invention may be embodied in many other forms.

### BACKGROUND OF THE INVENTION

Any discussion of the prior art throughout the specification should in no way be considered as an admission that such prior art is widely known or forms part of common general knowledge in the field.

Zinc metal is typically obtained by treating sulfide materials that contain zinc. In a widely used process, the sulfide materials are first roasted to convert zinc sulfide to zinc oxide, in accordance with the following reaction (1):

2ZnS+3O_{2 (g)}→2ZnO+2SO_{2 (g)} (1)

Typically, up to 90% of zinc sulfide in the ores or concentrates is oxidised to zinc oxide. However, around 10% of the zinc reacts with iron impurities in the concentrates to form zinc ferrite. The sulfur dioxide gas that is formed in the roaster may be captured in the flue gas and converted into sulfuric acid.

The roasted ore or concentrate is then leached in an acid leaching process to form a pregnant leach solution containing dissolved zinc. Sulfuric acid is widely used as the leaching agent and this results in the formation of a zinc sulfate leaching solution. The zinc sulfate leaching solution is then subjected to electrolysis to recover zinc metal.

The solid residue from the leaching step contains valuable metals (such as Cu, Ag, Au and undissolved Zn). There are numerous commercial methods for recovering the valuable materials (Cu, Ag, Au and Zn) from the leach residue of a zinc refinery and producing a waste product. Due to the combination of other elements in the zinc leach residues (such as S, Si, Fe, Ca, Pb and As), all of the existing metallurgical methods of treating zinc leach residues suffer to some degree from adverse economic and/or adverse environmental outcomes. Hydrometallurgical routes (for example: strong acid leaching plus production of jarosite) have the effect of making the zinc refinery intolerant of SiO₂-rich zinc concentrates, due to the propensity of SiO₂ to dissolve and create gel when residues are subjected to high acid concentrations; while simultaneously the hydrometallurgical jarosite-rich residue that is created is not universally considered to be an acceptable material for disposal by all government jurisdictions. On the other hand, pyrometallurgical methods (for example: solid-state fuming in a Waelz kiln, or liquid-state fuming in a top submerged lance (TSL) furnace) generate low-strength SO₂ gas that is either discharged or can be expensive to clean. The prior art of TSL fuming of zinc residues comprises WO 92/002648 as an example.

It is an object of the present invention to overcome or ameliorate at least one of the disadvantages of the prior art, or to provide a useful alternative.

Although the invention will be described with reference to specific examples it will be appreciated by those skilled in the art that the invention may be embodied in many other forms.

### SUMMARY OF THE INVENTION

The present invention is directed to a method for treating zinc leach residue, which may at least partially overcome at least one of the abovementioned disadvantages or provide the consumer with a useful processing or commercial choice.

With the foregoing in view, the present invention in one form, resides broadly in a method for treating zinc leach residue comprising adding a zinc leach residue and a sulfide material containing copper and flux to a furnace having a molten bath therein, operating the furnace to produce a matte containing copper and a slag containing zinc, separating the matte from the slag, recovering copper from the matte and recovering zinc from the slag.

According to a first aspect of the present invention there is provided a method for treating a zinc leach residue comprising the steps of:
adding the zinc leach residue and a sulfide material comprising copper and flux to a furnace having a molten bath therein;
operating the furnace to produce a matte comprising copper and a slag comprising zinc;
separating the matte from the slag; and
recovering zinc from the slag.

In one embodiment, the method comprises treating the slag in a slag fumer or a slag fuming furnace to recover zinc therefrom. In one embodiment, molten slag from the furnace is treated in the slag fumer/slag fuming furnace.

In one embodiment, the method comprises treating the matte in a copper smelter to recover copper therefrom. In one embodiment, molten matte from the furnace is treated in the copper smelter.

In an embodiment, the method further comprises the step recovering one or more precious metals from the matte. Preferably, the one or more precious metals comprise silver and gold.

In one embodiment, the furnace comprises a top-blown submerged-combustion lance furnace, commonly known as a TSL furnace. An example of such a suitable furnace is one available from the present applicant and sold under the trademark ISASMELT™.

In one embodiment, the furnace is operated at an oxygen partial pressure between 10^{-9.5} and 10^{-7.5} atm, or between 10⁻⁹ and 10⁻⁸ atm, most preferably about 10^{-8.5} atm.

In one embodiment, air, oxygen, or oxygen-enriched air is added to the furnace.

In one embodiment, off gases from the furnace contain sulfur dioxide and the off gases are sent to an acid plant to produce sulfuric acid therefrom. The acid plant may utilise known, conventional technology and need not be described further.

In one embodiment, fuel is added to the furnace. The fuel may comprise coal, oil, natural gas, or a mixture thereof.

In one embodiment, fluxes are added to the furnace. The fluxes may comprise silica, limestone (or another source of CaO). The person skilled in the art will understand that there may be a lot of silica and gypsum present inside the zinc residues, and the SiO₂ and CaO therein may themselves comprise a large proportion of the required fluxes, thus minimising the expense of purchasing dedicated flux materials.

In one embodiment, the fluxes and feed added to the furnace are selected or controlled to produce a slag with a zinc content in the range of 10-20 wt. %, preferably about 10, 11, 12, 13, 14, 15, 16, 17, 18, 19 or about 20 wt. %.

Preferably, the CaO/SiO₂ ratio of the slag is maintained between about 0.1 to 0.3, preferably about 0.1, 0.15, 0.2, 0.25 or 0.3 and the ratio of SiO₂/(Fe+Zn) is between 0.6-0.8, preferably about 0.6, 0.65, 0.7, 0.75 or 0.8. The person skilled in the art will realise that simple calculations based on the composition of the feed and fluxes can be used to determine the fluxes to use and the amount of those fluxes to add.

In one embodiment, the furnace is operated at a temperature of less than 1250° C., or less than 1220° C., or less than 1200° C. In one embodiment, the furnace is operated at a temperature of from 1100° C. to 1250° C., or from 1150° C. to 1220° C., or from 1175° C. to 1200° C. n an embodiment, the furnace is operated at a temperature of about 1100, 1120, 1140, 1160, 1180, 1200, 1220, 1240° C.

In one embodiment, the slag is tapped from the furnace in a molten state and the molten slag is sent to the zinc fumer/zinc fuming furnace. In one embodiment, the matte is tapped from the furnace in a molten state and the molten matte is sent to the copper smelter.

In one embodiment, a molten mixture of molten slag and molten matte is removed from the furnace and sent to a settling furnace, and the molten slag is removed from the settling furnace and sent to the zinc fumer/zinc fuming furnace, and molten matte is removed from the settling furnace and sent to the copper smelter.

In one embodiment, the slag contains between 5 to 25 wt. % zinc, or more suitably from 10 to 20 wt. % zinc, most preferably about 15 wt. % zinc, when the slag leaves the furnace.

In one embodiment, the slag is treated in a slag fuming furnace and a gaseous stream containing fumed zinc is formed, and zinc is recovered therefrom. A copper speiss and/or an inert slag may also be formed in the slag fuming furnace.

The matte formed in the furnace may suitably contain between 40 to 75% copper and this matte will be suitable for addition to a normal copper smelter for downstream processing (i.e., converting). Advantageously, precious metals in the zinc residue (including gold and silver) will report to the matte and can be separately recovered in the copper smelting plant.

In one embodiment, the furnace is operated such that a copper-containing matte is formed, which really digests substantially all of the incoming precious metals in the feed materials to the furnace, but most of the zinc in the feed will preferentially report to the slag phase.

In preferred embodiments of the present invention, zinc leach residues can be treated with sulfide materials containing copper to obtain high recoveries of the valuable elements copper, silver, gold and zinc. A gas rich in sulfur dioxide is formed and this is suitable for feeding to a conventional acid plant, such as a conventional metallurgical acid plant. In some embodiments, an inert slag or a glassy solid material containing Fe, Ca, Al, and Si is formed, in which any residual amounts of Pb and As will be chemically inert. This inert slag or glassy solid material may be suitable for sale or disposal.

According to a second aspect of the present invention there is provided zinc, when recovered from a zinc leach residue by a method according to the first aspect of the present invention.

According to a third aspect of the present invention there is provided copper, when recovered from a sulfide material comprising copper and flux by a method according to the first aspect of the present invention.

According to a fourth aspect of the present invention there is provided one or more precious metals comprising silver and/or gold when extracted from a zinc leach residue by a method as defined according to the first aspect of the invention.

### Definitions and Nomenclature

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %”, “ratio” will mean “weight ratio” and “parts” will mean “weight parts”.

The term “substantially” as used herein shall mean comprising more than 50% by weight, where relevant, unless otherwise indicated.

The term “about” should be construed by the skilled addressee having regard to normal tolerances in the relevant art.

Throughout this specification, all percentages are given as weight percentages (wt. %) unless stated otherwise (e.g., vol. %).

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a flowsheet of a process in accordance with one embodiment of the present invention;

FIG. 2 shows a pseudo-ternary phase diagram of SiO₂—FeOₓ—ZnO with fixed CaO content of 6 wt. % and fixed pO₂ of 10⁻⁸ atm. Yellow region denotes slag fully liquid at temperature of 1250° C. This diagram is reproduced from paper by: Liu, H., Cui, H., Chen, M., and Zhao, B. “Phase Equilibria in the ZnO-“FeO”-SiO₂—CaO System at pO₂ 10⁻⁸ atm”, Calphad, v. 61 (2018) pp. 211-218;

FIG. 3 shows a diagram of slag liquidus temperatures, calculated for various mass ratios of CaO/SiO₂, using the ‘FTOxide’ database of FACTSAGE;

FIG. 4 shows a diagram of activity coefficient of ZnO (γ_{ZnO}) and activity of ZnO (a_{ZnO}), calculated for various mass ratios of CaO/SiO₂, using the ‘FTOxide’ database of FACTSAGE;

FIG. 5 shows a diagram showing the effect of slag temperature on partial pressure of Zn, calculated for various oxygen potentials, using the ‘FTOxide’ database of FACTSAGE.

### DESCRIPTION OF A PREFERRED EMBODIMENT

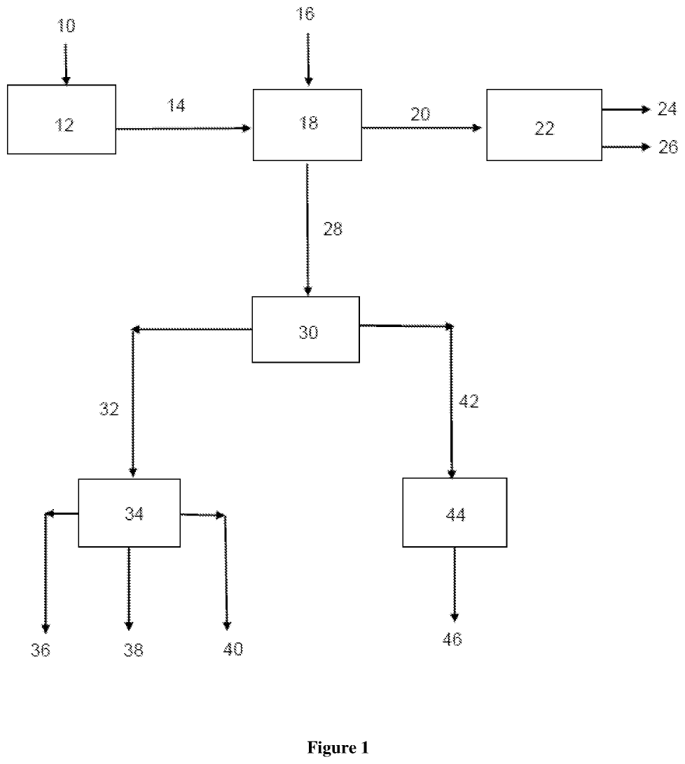

The flowsheet shown in FIG. 1 is a flowsheet of one embodiment of the present invention. The flowsheet of FIG. 1 is a method for the pyrometallurgical processing of zinc leach residue mixed with sulfide copper materials that allows for good recovery of zinc and precious metals from the zinc leach residue. In the flowsheet shown in FIG. 1, zinc leach residues, sulfide copper materials, fluxes, and fuel, represented collectively by reference numeral 10, are fed to a feed preparation plant 12.

The mixed feed 14 is then supplied to a TSL furnace, in this case an ISASMELT™ top submerged lance furnace, 18. Air enriched with oxygen and, optionally, fuel 16 are fed to the TSL through the lance 16. The ISASMELT™ furnace 18 smelts the incoming feed materials in a turbulent bath to produce a molten slag and a molten copper matte. Most of the zinc in the feed materials reports to the slag and most of the copper, silver and gold in the feed materials report to the matte.

In a preferred embodiment, the ratio of oxygen-enriched air and fuel is controlled so that the oxygen potential or oxygen partial pressure of the furnace is maintained in the range of 10^{-9.5} to 10^{-7.5} atm, or from 10⁻⁹ to 10⁻⁸ atm. The copper matte that is formed readily digests most of the incoming precious metals but, as mentioned above, most of the zinc in the feed will report preferentially to the slag phase.

The ratio of feed materials and fluxes added to the ISASMELT™ furnace 18 is controlled to obtain a fluid slag that contains a generous amount of recoverable zinc. The slag will suitably contain between 5 to 25% zinc, and more suitably it will contain 10 to 20% zinc when it leaves the ISASMELT™ furnace 18. In the choice of slag composition and smelting temperature, processing conditions specific to preferred embodiments of this invention has been developed.

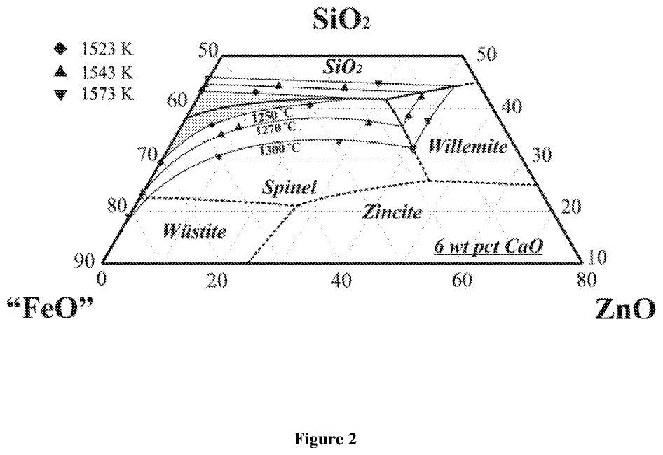

Experimentally determined slag liquidus temperatures at the relevant conditions are normally considered the best type of fundamental science relevant to smelter design. For example, FIG. 2 shows (in yellow) a tight confinement to the permissible slag composition consistent with a fully liquid slag containing ZnO, SiO₂, FeOₓ and CaO in equilibrium with an atmosphere containing an oxygen partial pressure of 10⁻⁸ atm. If reliant only on fundamental science, the choice of operating parameters would be made according to such a diagram.

However, it is a feature of this invention that the fundamental science published up until today is usually not sufficient to adequately define some nuances about the achievable parameters for smelting. In particular, two real-world phenomena appear to allow practical smelting operation to deviate noticeably from laboratory measurements and computational predictions.

Firstly, sulfur in the furnace, present in both the copper matte and the SO₂-rich off-gas, partially invalidates published phase diagrams that have been calculated or experimentally derived from sulfur-free systems. With sulfur present in the furnace, slags with great fluidity are obtainable at temperatures up to 70° C. below the experimentally-determined liquidus.

Secondly, the ISASMELT™ furnace is able to operate reliably while producing slags at slightly sub-liquidus temperatures. Such slags might best be thought of as high-temperature slurries, with a small proportion of suspended solid particles inside a large fraction of liquid. Thus the ISASMELT™ furnace (item 18 of FIG. 1) can smelt a mixture of zinc residues and sulfide copper materials satisfactorily at a temperature below 1200° C. while producing a slag with a zinc content in the range of 10-20 wt. %, providing that the CaO/SiO₂ ratio of the slag is maintained between 0.1 to 0.3 and the ratio of SiO₂/(Fe+Zn) is between 0.6-0.8.

The off gases 20 from the ISASMELT™ furnace 18 are rich in sulfur dioxide (SO₂), and desirably have a zinc fume content as low as possible. The generation of zinc fumes inside the ISASMELT furnace is unwelcome because it decreases the proportion of zinc reporting to the slag as ZnO, and therefore decreases the recovery of zinc through the subsequent slag fuming furnace (item 34 in FIG. 1).

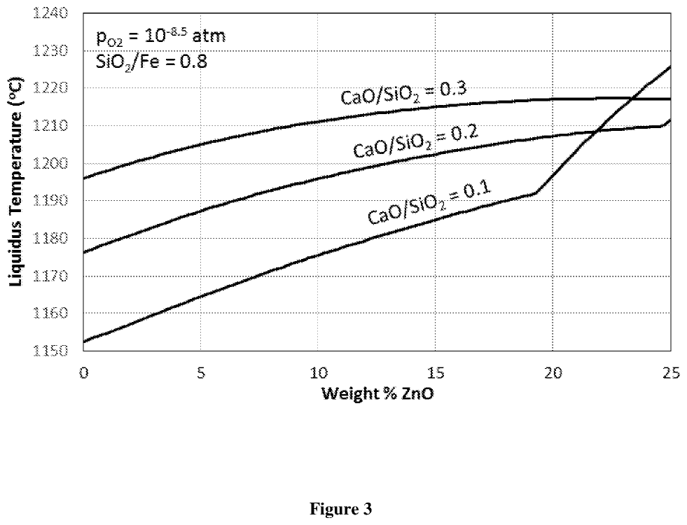

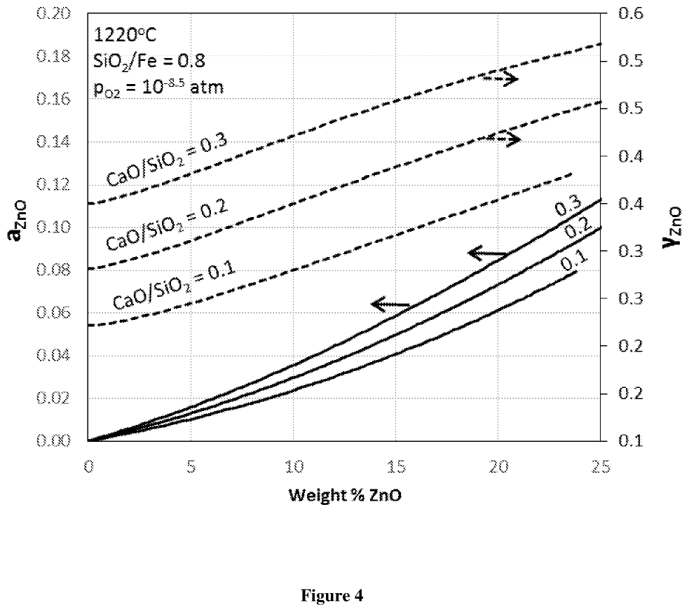

It is well known to those skilled in the art, that furnaces tend to fume zinc out of slag very much faster when the concentration of CaO in the slag is increased, and when the slag temperature is increased. Compared to a conventional slag fuming furnace, where the CaO/SiO₂ ratio in slag is typically around 0.7, there are two reasons why a lesser concentration of CaO is desirable in the slag of the ISASMELT™ furnace of embodiments of the current invention. Firstly, modest increases in the CaO/SiO₂ ratio increase the liquidus temperature of the slag (as depicted in FIG. 3) and require the smelting temperature of the ISASMELT™ furnace to be increased in response. Secondly, the activity coefficient of ZnO in the slag (γ_{ZnO}) becomes higher when the CaO/SiO₂ ratio in slag is increased (as depicted in FIG. 4).

The increased γ_{ZnO} causes the ZnO activity to be greater at any fixed concentration of ZnO in slag, and therefore more zinc will unhelpfully report to the fume during smelting in the ISASMELT™ furnace, according to such reactions as the following equation (2):

ZnO+CO_{(g)}→Zn_{(g)}+CO_{2 (g)} (2)

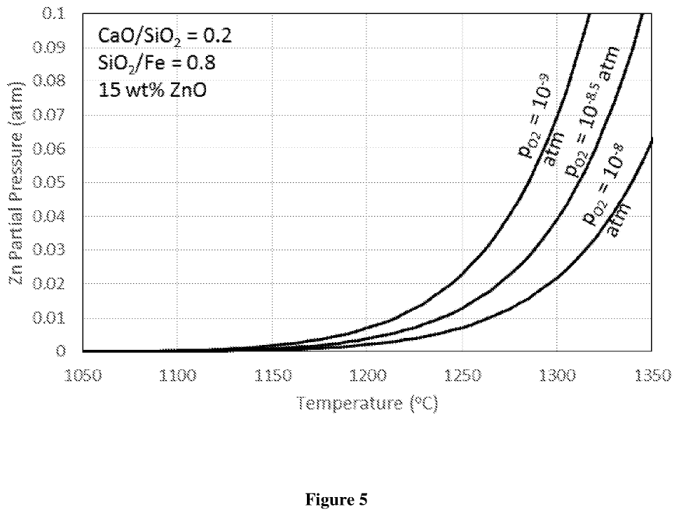

As can be seen in FIG. 5, having controlled the CaO/SiO₂ ratio and other slag composition parameters carefully, the amount of zinc that reports to the gas phase is largely a function of furnace temperature, which in embodiments of this invention is also controlled below 1220° C. and preferably below 1200° C. The off gases 20 are sent to an acid plant 22 of conventional construction and operation where the off gases 20 are treated to form sulfuric acid 26 and an acid plant tail gas 24 from which the sulfur dioxide has largely been removed. The acid plant tail gas 24 may be vented to atmosphere through a flue or chimney, via methods well known to those skilled in the art.

Due to the turbulent nature of the molten bath in the ISASMELT™ furnace 18, the slag and the matte are mixed with each other. A mixture of the slag and matte 28 is removed from the ISASMELT™ furnace 18 and sent to a settling furnace 30. The settling furnace 30 is operated under relatively quiescent conditions and at a temperature that maintains the slag and the matte in molten state. The slag will separate from the matte, with the slag typically collecting on top of the matte in the settling furnace 30.

The zinc rich slag 32 is removed from the settling furnace 30 and sent to slag fuming furnace 34. Slag fuming furnace 34 is of conventional construction and operation and need not be described further. In the slag fuming furnace 34, zinc vaporises and is removed as a zinc fume 36. The zinc fume 36 comprises a gaseous stream containing vaporised zinc. Zinc can be recovered from the zinc fume 36 in accordance with known recovery processes. A copper speiss 38 and an inert slag 40 are also removed from the slag fuming furnace 34.

The copper speiss 38 and inert slag 40 may be removed in the molten state and allowed to solidify after removal from the furnace. The copper speiss may be sent for further treatment to recover copper therefrom. The inert slag 40 will form a glassy material when solidified. The inert slag 40 will contain Fe, Ca, Al, and Si compounds and any residual amounts of lead and arsenic will be chemically inert or bound within the inert slag, thereby rendering the inert slag suitable for disposal.

The copper matte 42 that is formed in the ISASMELT™ furnace 18 is sent to a conventional copper smelter 44. The ISASMELT™ furnace 18 is suitably operated such that partial combustion is achieved in the ISASMELT™ furnace 18 such that many of the gaseous components are substantially oxidised but leaving some uncombusted FeS, ZnS. Cu₂S and PbS to form the molten matte in the bottom of the furnace. The composition of the matte depends upon how much uncombusted sulfide species are allowed to remain. The resulting matte will desirably contain between 40 to 75% copper which corresponds to an approximate partial pressure of oxygen, inside the ISASMELT™ furnace, between 10⁻⁹ atm and 10⁻⁸ atm.

As FIG. 5 depicts, the oxygen potential of the ISASMELT™ furnace does affect the partial pressure of Zn_{(g)} in the furnace. As the matte grade is raised from 40 to 75% Cu, the oxygen potential rises from 10⁻⁹ atm to 10⁻⁸ atm, and the proportion of zinc reporting to fume according to reaction (2) is decreased. Other precious metals in the feed, such as gold and silver, also report to the matte phase. The matte 42 is suitable for addition to a normal copper smelter 44 for downstream processing. One product from the copper smelter 44 is recovered copper 46 with dissolved silver and gold.

Typical zinc leach residues that can form part of the feed to the ISASMELT™ furnace 18 have the following range of compositions (Table 1):

TABLE 1
Range of compositions of typical zinc leach residues
fed to the ISASMELT ™ furnace

| Species | Zn | Cu | Fe | S | CaO | SiO₂ | Ag | Au |
|---|---|---|---|---|---|---|---|---|
| Wt. % | 10-25 | 0-5 | 10-25 | 3-9 | 0-3 | 2-10 | 0-0.1 | 0-0.01 |

Typical sulfide copper materials that form part of the feed to the ISASMELT™ furnace 18 have the following range of compositions (Table 2):

TABLE 2
Range of compositions of typical sulfide copper materials
fed to the ISASMELT ™ furnace

| Species | Zn | Cu | Fe | S | CaO | SiO₂ | Ag | Au |
|---|---|---|---|---|---|---|---|---|
| Wt. % | 0-5 | 5-30 | 10-35 | 25-35 | 0-3 | 2-20 | 0-0.1 | 0-0.01 |

Owing to the minerals present in a zinc leach residue, which tend to be oxides and sulfates and their hydrated counterparts, its smelting tends to be endothermic, requiring a large energy input. Owing to the minerals present in the sulfide copper material, its smelting tends to be exothermic, and plentiful heat is generated. Coolant is sometimes required to maintain stable temperatures in a commercial Copper ISASMELT™ furnace. The combination of the two materials into a single smelting process is advantageous from this perspective.

### Example

Industrial-scale tests were conducted at an operating ISASMELT™ facility employing a campaign of continuous furnace operation performed over two calendar days. The ISASMELT™ furnace used in the trial had a cylindrical vessel with a flat roof. The feed material was blended from a combination of zinc residues, sulfide copper concentrates and other smelter recycle streams.

The blended wet feed, along with silica/quartz flux and solid fuel was continuously transferred and discharged into the furnace by a series of conveyors. A central lance injected air, oxygen and trim fuel into the molten bath. The lance was sufficiently immersed into the molten bath so that the injected air, oxygen, and trim fuel created in a high level of agitation of the liquid, ensuring a rapid reaction between the raw materials and the oxygenated slag bath.

The average composition of the blended feed is shown in Table 3 and the average key furnace parameters from the trial are shown in Table 4.

TABLE 3
Average concentrate composition from Plant Trial

| Element | Cu | Pb | Zn | Fe | S | SiO₂ | CaO | MgO | Al₂O₃ |
|---|---|---|---|---|---|---|---|---|---|
| Unit | Wt. % | Wt. % | Wt. % | Wt. % | Wt. % | Wt. % | Wt. % | Wt. % | Wt. % |
| Assay | 10.84 | 5.30 | 10.01 | 20.80 | 21.16 | 6.20 | 1.33 | 0.58 | 4.59 |

TABLE 4
ISASMELT ™ furnace parameters

| Parameter | Average Value |
|---|---|
| Blended concentrate rate (dmt/h) | 39.0 |
| Solid fuel rate (dmt/h) | 2.96 |
| Silica/quartz rate (dmt/h) | 4.21 |
| Lance process air (Nm³/h) | 6400 |
| Lance process oxygen (Nm³/h) | 7120 |

### Test Results

The industrial trial confirmed that the feed materials were successfully incorporated into the bath and formed separate matte and slag phases. Removal of the molten products was achieved by opening a single taphole at the base of the furnace and settling of the materials was performed in the site 3-in-line electric furnace.

During the trial process off-gases passed through a waste heat boiler and an electrostatic precipitator for removal of dust prior to being directed to the site acid plant for desulfurisation. The operation of the off-gas handling system was successfully able to achieve the targets at each system interface, most notably the exit temperature of the waste heat boiler was able to be kept between 340-360° C. and the SO₂ concentration in the off-gas to the acid plant was maintained between 11-13 vol. %.

During the industrial trial samples were taken using cast iron spoons for the molten phases, whilst traditional sampling methods were used for the other solid streams. Samples were ground and analysed by X-ray fluorescence (XRF).

The production rates and compositions of key phases are shown in Table 5 and Table 6, respectively.

The assays and mass flows confirmed the majority of the zinc, over 80%, in the feed materials reported to the slag phase in the furnace. The data confirmed that 95% of the copper, and hence by association silver and gold in the feed materials, reported to the matte phase. Fluid slags were attained during the industrial campaign with the actual CaO/SiO₂ ratio of the slag maintained at 0.22 (target between 0.1 to 0.3) and the actual SiO₂/(Fe+Zn) ratio of the slag maintained at 0.63 (target between 0.6-0.8).

TABLE 5
ISASMELT ™ furnace parameters

| Parameter | Value |
|---|---|
| Settled Slag (t slag/t concentrate) | 0.604 |
| Settled Matte (t matte/t concentrate) | 0.191 |
| Combined Dust (t dust/t concentrate) | 0.060 |

TABLE 6
ISASMELT ™ furnace parameters

| Parameter | Cu | Zn | Fe | S | SiO₂ | CaO |
|---|---|---|---|---|---|---|
| Units | Wt. % | | | | | |
| Settled slag | 0.8 | 14.0 | 30.8 | 0.4 | 28.4 | 6.3 |
| Settled matte | 54.0 | 3.3 | 7.6 | 16.2 | 0.6 | — |
| Combined dust | 1.1 | 18.7 | — | — | — | — |

The ISASMELT™ furnace bath temperature was measured continuously during the trial, averaging 1175° C. (target less than 1200° C.), using a thermocouple placed through the refractory lining of the furnace. Confirmation of the bath temperature was obtained using a disposable dip-tip measurement during tapping.

The molten matte was treated in the broader copper smelter flowsheet and furnace of the site and successfully converted to blister copper and fire refined to anode copper prior to electrolytic refining. The precious metals slimes was recovered after the copper refining was completed and put through a standard process for the production of separate precious metals streams. The molten slag was treated at the site for zinc recovery. This confirmed the process flowsheet shown in FIG. 1.

The process shown in FIG. 1 allows the following desirable outcomes to be achieved:
a) Obtain high recoveries of one or more valuable elements selected from Cu, Ag, Au and Zn.
b) Create an SO₂-rich gas that is suitable for feeding to a conventional metallurgical acid plant.
c) Create a glassy solid slag material for sale or disposal of the elements Fe, Ca, Al and Si in which any residual amounts of Pb and As will be chemically inert.

### INDUSTRIAL APPLICABILITY

The invention as described above relates to a method for treating zinc leach residue. Zinc leach residue, produced from traditional zinc hydrometallurgy processes, is not only a hazardous waste but also a potential valuable solid. The invention as described thereby demonstrates industrial applicability in the economic value of the zinc recovered, and environmental efficacy by remediating an otherwise hazardous waste material.

Furthermore, the inventive method provides means for recovering precious metals such as silver and gold from zinc residues. Such precious metals had often gone unrecovered due to process efficiencies and practical difficulties in extracting them from the zinc residue. In the present invention, such precious metals report to the copper-containing matte, from which they may be extracted or on-sold either as the matte, per se, or by converting it to copper cathode and anode slimes.

1. A method for treating a zinc leach residue comprising the steps of:
adding the zinc leach residue and a sulfide material comprising copper and flux to a furnace having a molten bath therein;
operating the furnace to produce a matte comprising copper and a slag comprising zinc;
separating the matte from the slag; and
recovering zinc from the slag,
wherein the matte formed in the furnace comprises between about 40 to 75% copper.

2. A method according to claim 1, further comprising the step of recovering the copper from the matte.

3. A method according to claim 1, further comprising the step of treating the slag in a slag fumer or a slag fuming furnace to recover the zinc therefrom.

4. A method according to claim 1, further comprising the step of treating the matte in a copper smelter to recover copper therefrom.

5. A method according to claim 4, further comprising the step of recovering one or more precious metals from the final product of the smelter.

6. A method according to claim 5, wherein the one or more precious metals comprise silver and gold.

7. A method according to claim 1, wherein the furnace comprises a top-blown submerged-combustion lance (TSL) furnace.

8. A method according to claim 1, wherein the furnace is operated at an oxygen partial pressure between about 10^{-9.5} and 10^{-7.5} atm.

9. A method according to claim 1, wherein the furnace is operated at an oxygen partial pressure of about 10^{-8.5} atm.

10. A method according to claim 1, further comprising the step of adding air, oxygen, and/or oxygen-enriched air to the furnace.

11. A method according to claim 1, wherein off gases from the furnace contain sulfur dioxide and are sent to an acid plant to produce sulfuric acid therefrom.

12. A method according to claim 1, further comprising the step of adding one or more fluxes to the furnace.

13. A method according to claim 12, wherein the one or more fluxes comprise silica, limestone, or another source of CaO.

14. A method according to claim 12, wherein the fluxes and feed added to the furnace are selected or controlled to produce a slag with a zinc content in the range of about 10-20 wt. %.

15. A method according to claim 1, wherein the slag has a CaO/SiO₂ ratio of between about 0.1 to 0.3.

16. A method according to claim 1, wherein the slag has a ratio of SiO₂/(Fe+Zn) of between about 0.6 to 0.8.

17. A method according to claim 1, wherein the furnace is operated at a temperature of about 1100° C. to 1250° C.

18. A method according to claim 1, further comprising the step of tapping the slag from the furnace in a molten state, wherein the molten slag is sent to a zinc fumer/zinc fuming furnace.

19. A method according to claim 1, further comprising the step of tapping the matte from the furnace in a molten state, wherein the molten matte is sent to a copper smelter.

20. A method according to claim 1, wherein the slag contains between about 5 to 25 wt. % zinc, when the slag leaves the furnace.

21. (canceled)

22. A method according to claim 1, wherein the copper-containing matte substantially digests any incoming precious metals with the exception of the zinc which reports preferentially to the slag phase.

23. A method according to claim 1, wherein an inert slag or a glassy solid material comprising Fe, Ca, Al, and Si is formed as a by-product.

24. Zinc, when recovered from a zinc leach residue by a method according to claim 1.

25. Copper, when recovered from a sulfide material comprising copper and flux by a method according to claim 1.

26. One or more precious metals comprising silver and/or gold when extracted from a zinc leach residue by a method as defined according to claim 5.
